(19) United States
(12) Patent Application Publication
(10) Pub. No.: US 2016/0051936 A1
(43) Pub. Date: Feb. 25, 2016

(54) CENTRAL BAFFLE AND PRESSURE-TYPE HOLLOW FIBER MEMBRANE MODULE COMPRISING THE SAME AND ITS CLEANING METHOD

(71) Applicant: Econity Co., Ltd., Gyeonggi-do (KR)

(72) Inventors: Jin-Ho KIM, Gyeonggi-do (KR); Nam-Seok GIL, Gyeonggi-do (KR); Min-Soo PARK, Gyeonggi-do (KR)

(21) Appl. No.: 14/777,803

(22) PCT Filed: Mar. 18, 2013
(86) PCT No.: PCT/KR2013/002196

§ 371 Date: Sep. 17, 2015

(30) Foreign Application Priority Data
Mar. 18, 2013 (KR) 10-2013-0028607

(51) Int. Cl. B01D 65/02; B01D 63/02

(52) U.S. Cl. CPC B01D 65/02; B01D 63/02; B01D 2321/04; B01D 2321/185

(57) ABSTRACT

The present disclosure relates to a structure of a pressure-type hollow fiber membrane module and its cleaning method, and more particularly, to a pressure-type hollow fiber membrane module with a central baffle in which the central baffle has a cylindrical shape with a hollow inside the module. The module includes an air zone with at least one backwash hole passing therethrough and a water zone with at least one backwash hole passing therethrough. The central baffle is installed on the same axis as a concentration part at the center of the pressure-type hollow fiber membrane module to allow a uniform flow of concentrated water and cleaning air in all directions.

### TECHNICAL FIELD

The present disclosure relates to a structure of a pressure-type hollow fiber membrane module and its cleaning method, and more particularly, to a central baffle of a cylindrical shape having a hollow within a membrane module, including an air zone with at least one backwash hole passing therethrough regularly or irregularly on an outer circumference of the air zone and a water zone with at least one backwash hole passing therethrough regularly or irregularly on an outer circumference of the water zone, and a pressure-type hollow fiber membrane module in which the central baffle is installed on the same axis as a concentration part at the center of the pressure-type module to allow an uniform flow of concentrated water and cleaning air in all directions of a housing and prevent a phenomenon in which the pressure and linear velocity increases or remains stagnant occurring in traditional modules, thereby increasing a mechanical cleaning effect and reducing membrane fouling. Also, the present disclosure relates to a two-stage backwash method that improves maintenance and management of the pressure-type hollow fiber membrane module with the central baffle having an advantage of a smooth movement of air and backwash water by a motion or movement of membranes under high pressure and air injection during backwash and reduces a total amount of energy used, thereby reducing a membrane operation cost and maximizing a cleaning effect.

The present application claims priority to Korean Patent Application No. 10-2013-0028607 filed on Mar. 18, 2013 in the Republic of Korea, the disclosures of which are incorporated herein by reference.

### BACKGROUND ART

Separation, purification, and fractionation using membranes is being widely used all over the field of industries, and a hollow fiber membrane module in use for filtration and dialysis of materials by a liquid to be treated and a treated liquid can increase an effective membrane area per unit volume, and thus has a wide range of application in the field of water treatment including micro-filtration and ultra-filtration, gas separation, medicine, and bio-industries until now. However, generally, when an attempt is made to separate a particulate material or a solute present in a solution using membranes, because particles to be eliminated from the solution has a very low dispersion velocity, even if a concentration gradient between a center area and a membrane surface is great, back-dispersion does not easily take place, so a concentration polarization phenomenon occurs in which a solute concentration near the membrane surface increases or a phase transition to a solute continuous phase occurs on the membrane surface, and as a consequence, a solute layer is formed and a membrane fouling phenomenon occurs, for example, small solute particles are absorbed into the walls of large pores and the pores are closed by particles of a similar size to the pores.

Thus, due to these phenomena, as an operation time increases, a permeate flux rate of the membranes reduces and the trans-membrane pressure rises, and cleaning using backwashing, air scouring, or chemicals needs to be carried out.

In the case of hollow fiber membranes, for actual application to an industrial process, a module with a large amount of hollow fiber membranes bonded in a bundle form is used, and a typical type of a general pressure-type module has a structure as shown in FIG. 1 in which an inlet part 3 through which raw water is injected is provided at a lower portion of the module, so the raw water flows in at the lower portion and moves into the hollow fiber membranes between urethane potting where the hollow fiber membranes are held, filtered water flows out of a filtration part 1 installed at the top, a concentration part 2 configured to discharge concentrated water not passing through the hollow fiber membranes is installed on the side at an upper portion of the module and an air injection part 4 is installed at the bottom of the module. According to the structure of the general pressure-type module, as shown in FIG. 6, concentrated water generated after treatment of inflowing raw water and backwash water and air injected for backwash or air scouring passes along an asymmetrical movement channel between the inlet part at the lower portion of the module and the concentration part on the side at the upper portion, and by this flow of water and air, the hollow fiber membranes move in one direction, and thus, the pressure and linear velocity is not uniform within the module (see FIG. 6), and when a backwash process and an air scouring process are performed in the event of membrane module fouling, stresses applied to or around the concentration part increases, and as a result, the membrane may be cut off or stretched and a bottleneck phenomenon (congestion phenomenon) of concentrated water may occur.

Conventionally, the pressure-type membrane module removes membrane contaminants generated during operation by a backwash process, but a traditional backwash process fails to completely remove membrane contaminants on the membrane surface, and although an air scouring process is used for effective cleaning, a dead zone is generated in a flow of backwash water due to the structural problem with a drain pipe of the pressure-type membrane module located on the side of the module, and as a result, elimination of membrane fouling is not uniform and a space where air stays is formed within the membrane module and obstructs the cleaning. Particularly, when a high turbidity material flows in, a serious membrane fouling phenomenon occurs and reduces a cleaning effect, and membrane contaminants are not completely removed, so periodic chemical cleaning is additionally needed and additional chemical cleaning increases costs of managing and operating a membrane filtration system.

Thus, in the design of hollow fiber membrane modules, attempts have been made on technical development of a membrane module with the introduction of a structure of a baffle shape to enable a smooth flow or uniform flow distribution of fluid such as treated water or cleaning air, and related arts are presented as follows.

KR2010-0129379A relates to a low fouling hollow fiber membrane module and a water treatment apparatus using the same, in which inflowing water comes into contact with a hollow fiber membrane while the inflowing water is rotating in a module, a rotary distribution plate induces impurities with different specific gravity from that of water to be separated from the inflowing water by the centrifugal force, and an inflowing water distribution port implements an equal distribution to prevent an unequal flow of inflowing water in the module, KR2004-0034492A and JP2009-195899A are directed to a hollow fiber membrane module in which a baffle barrel is embedded in the hollow fiber module, with a slit extending in a slanted direction with regard to an axis of a casing barrel on partition walls of the hollow fiber membrane module, to prevent the partition member from separating or escaping from the casing barrel and keep a treated liquid from flowing into the module, JP2010-247107A directed to a membrane module is characterized in that a baffle plate is provided in the module and configured to hold a plurality of hollow fiber membranes, to maintain a flow velocity of a supply liquid on the membrane surface at a high speed and in a turbulence state, to improve a flow of fluid in the membrane module, and a baffle structure is better than a module of a double tubular structure, JP1989-099611A drawn to a tubular membrane module is characterized in that a baffle plate has a plurality of holes to control a cylindrical flow of fluid to prevent the formation of contaminants within a cylindrical membrane filter or facilitate the removal of contaminants and to prevent a reduction in filtration efficiency, and the baffle plate is disposed on the same axis as a membrane cylinder at the center inside the membrane cylinder and is fixed at top and bottom.

However, the membrane module with the baffle structure according to the related art is just designed to induce an equal distribution in an aspect of inflowing water or to stably fix the partition member or prevent the formation of contaminants, and there is a technical limitation in solving the following problems: during operation of the hollow fiber module, the hollow fiber membranes incline in one direction and non-uniformity in internal pressure and linear velocity occurs, and when a backwash process and an air scouring process are performed in the event of membrane module fouling, stresses applied to the hollow fiber membranes around the concentration part increase, and as a result, the membrane is cut off or stretched and a bottleneck phenomenon (congestion phenomenon) of concentrated water occurs. There is a need for technology development of a new type of baffle structure which prevents an increase in pressure and linear velocity or a congestion phenomenon of concentrated water occurring in a pressure-type membrane module and achieves effective mechanical cleaning to reduce membrane fouling and increase a membrane usage time, and a pressure-type hollow fiber membrane module including the same and a new cleaning method that maximizes a cleaning effect of the pressure-type membrane module to improve the maintenance and management of a membrane filtration system and reduce a total amount of energy used and consequently a cost of operating the membranes.

### DISCLOSURE

### Technical Problem

The present disclosure introduced a central baffle of a cylindrical shape having a hollow within a pressure-type hollow fiber membrane module, including an air zone with at least one backwash hole passing therethrough regularly or irregularly on an outer circumference of the air zone and a water zone with at least one backwash hole passing therethrough regularly or irregularly on an outer circumference of the water zone, to allow an uniform flow of concentrated water and cleaning air in all directions inside the pressure-type module and prevent a phenomenon in which the pressure and linear velocity increases or remains stagnant occurring in traditional modules, thereby resolving the cut-off or stretching problem of a membrane and a bottleneck phenomenon (congestion phenomenon) of concentrated water, increasing a mechanical cleaning effect, and reducing membrane fouling, as well as allowing for smooth inflow/discharge of air and backwash water by a motion or movement of membranes under high pressure and air injection during backwash.

The air zone is located at an upper portion of the central baffle to allow for effective supply and discharge during air injection and discharge, and the water zone is located at a lower portion of the central baffle to facilitate the discharge of concentrated water and inflow of backwash water, a size of the backwash hole formed passing therethrough on the outer circumference of the air zone of the central baffle is larger than a size of the backwash hole formed passing therethrough on the water zone to allow for a smooth movement of air and backwash water by a motion or movement of the membranes during air injection, and an area of the water zone is larger than an area of the air zone to allow for an effective movement of air and treated water.

As shown in FIG. 1, the traditional pressure-type module includes the concentration part 2 located on the side of the upper portion of the module, through which concentrated water is discharged, and the inlet part 3 and the filtration part 1 located at the center of the upper portion and the lower portion of the module, but as shown in FIG. 4, according to the pressure-type module of the present disclosure, a central baffle at the center of the upper portion of the module is disposed at the center of a concentration part 20, a filtration part 10 is provided on the side of the upper portion of the module, a raw water inlet part/air injection part 30 is provided at the bottom of the module, and an outlet part of concentrated water and air is located at the center of a housing, so a distance from the edge of the housing to concentrated water is uniform and thus a movement of concentrated water and air is uniform.

Also, according to the membrane module of the present disclosure, hollow fiber membranes are arranged in a radial pattern of a concentric circle with regard to the center of the module and the central baffle is located at its center, so water purification treatment and cleaning effects by the hollow fiber membranes are uniform, the entire hollow fiber membrane is equally used, and a membrane usage time is long.

When compared to a general traditional membrane cleaning process involving simultaneous operation of respective two processes including a backwash process which flows filtered water in the opposite direction of filtration and an air scouring process which scours the membrane surface using air, the pressure-type hollow fiber module with the central baffle has a membrane fouling reduction effect and an advantage of maximizing a reduction in membrane maintenance and management cost through the application of a two-stage backwash process including two stages, a first stage and a second stage divided based on a backwash time in which the amount of backwash water and the amount of backwash air differ for each stage, and in the first stage, the amount of backwash water is higher than the amount of backwash air, and in the second stage, the amount of backwash air is higher than the amount of backwash water, and thus, during the first stage, the high amount of water allows contaminants adhered to the inside of the module pores to be easily moved to the membrane surface, and during the second stage, the contaminants moved to the surface are effectively removed through an air scouring process using the increased amount of air.

Particularly, the first stage was performed at the amount of backwash water of 1.5 Q˜2.5 Q that is 1.5 to 2.5 times higher than the amount of filtration water (Q) and the amount of backwash air of 100˜250 L/min (LPM) that is 1/3 to 2.5/3 times higher than a traditional amount of backwash air (300 L/min, LPM), and then, the second stage was performed at the amount of backwash water of 0.5 Q˜1.5 Q that is 0.5 to 1.5 times higher than the amount of filtration water and the amount of backwash air of 300˜450 L/min (LPM) that is 1 to 1.5 times higher than the traditional amount of backwash air (300 L/min, LPM).

When the pressure-type membrane module with the central baffle is used, a backwash time, i.e., an operation time of the entire backwash process including the first stage and the second stage was set in the range of 30 to 90 seconds based on turbidity of inflowing raw water, the first stage and the second stage were performed during the same period of time or different periods of time to increase efficiency of the backwash process, and in particular, when the backwash time is 60 seconds as used in the general backwash process, the first stage and the second stage were equally performed for 30 seconds. Also, as a backwash mode is automatically selected and performed after turbidity of inflowing raw water is measured, the inflowing water with high turbidity may be effectively cleaned by changing the amount of backwash water and the amount of backwash air applied at each stage, and when normal raw water flows in, a lower amount of water and a lower amount of air than the existing cleaning level is achieved. Also, the introduction of the central baffle structure provides an advantage of a smooth movement of concentrated water and air, so effective injection and discharge is enabled when the amount of backwash water and the amount of backwash air increase during backwash.

### Technical Solution

The present disclosure introduces a central baffle of a cylindrical shape having a hollow inside of a pressure-type hollow fiber membrane module, including an air zone with at least one backwash hole passing therethrough regularly or irregularly along an outer circumference of the air zone and a water zone with at least one backwash hole passing therethrough regularly or irregularly along an outer circumference of the water zone, to allow concentrated water and cleaning air to uniformly flow in all directions within the pressure-type module and prevent the pressure and linear velocity from increasing or remaining stagnant occurring in traditional modules, thereby preventing a membrane from being cut off or stretched, resolving a bottleneck phenomenon (congestion phenomenon) of concentrated water, increasing a mechanical cleaning effect, and reducing membrane fouling, as well as allowing for smooth inflow/discharge of air and backwash water by a motion or movement of membranes under high pressure and air injection during backwash.

As the air zone is located at an upper portion of the central baffle, effective supply and discharge is enabled during air injection and discharge, and as the water zone is located at a lower portion of the central baffle, discharge of concentrated water and inflow of backwash water is performed favorably, and a size of the backwash hole formed passing therethrough on the outer circumference of the air zone of the central baffle is larger than a size of the backwash hole formed passing therethrough on the water zone, so a smooth movement of air and backwash water is enabled by a motion or movement of membranes during air injection, and an area of the water zone is greater than an area of the air zone, allowing effective movement of air and treated water.

In the pressure-type hollow fiber membrane module including an inlet part of raw water, a concentration part of treated water and a filtration part, the central baffle is located in a module housing on the same axis as the concentration part disposed at one end of the pressure-type hollow fiber membrane module, the inlet part of raw water is provided at the other end of the module housing, and the filtration part is provided on the side of the concentration part, so the central baffle and the concentration part serving as an outlet of concentrated water and air are located at the center of the housing and a distance from the edge of the housing to the central baffle is uniform, contributing to an uniform movement of concentrated water and air.

The present disclosure introduces the central baffle into the pressure-type hollow fiber membrane module to allow concentrated water and cleaning air to uniformly flow in all directions, and performs a backwash process which is divided into two stages to maximize a cleaning effect of a fouled membrane, and hereinafter, the central baffle according to the present disclosure, the pressure-type hollow fiber membrane module with the central baffle, a cleaning method of the pressure-type hollow fiber membrane module using the two-stage backwash process, and their effects are described in detail with reference to FIGS. 1 through 11.

A typical type of a general pressure-type hollow fiber membrane module has a structure as shown in FIG. 1 in which an inlet part through which raw water is injected is provided at a lower portion of the module, so the raw water flows in at the lower portion and moves into hollow fiber membranes between potting where the hollow fiber membranes are held, filtered water flows out of a filtration part installed at the top, and a concentration part configured to discharge concentrated water not passing through the hollow fiber membranes is installed on the side at the upper portion of the module, and the pressure-type hollow fiber membrane module removes membrane contaminants occurred during operation using a backwash process, but a traditional backwash process cannot completely remove contaminants on the membrane surface, and although an air scouring process is used for effective cleaning, due to the structural problem with the concentration part of the pressure-type hollow fiber membrane module located on the side of the module, as shown in FIG. 6, the injected raw water and air passes through the body and moves in one direction, the pressure and linear velocity increases, and as a consequence, the membrane may be cut off or stretched and a bottleneck phenomenon (congestion phenomenon) of concentrated water may occur, and furthermore, a dead zone is created in a flow of backwash water and impedes uniform elimination of membrane fouling and a space where air stay is formed within the membrane module and obstructs cleaning. Particularly, when a high turbidity material flows in, a serious membrane fouling phenomenon occurs and reduces a cleaning effect, and membrane contaminants are not completely removed, so periodic chemical cleaning is additionally needed and additional chemical cleaning causes an increase in costs of maintaining and operating a membrane filtration system.

Describing the pressure-type membrane module and the backwash method according to the related art with reference to FIG. 2, to perform the backwash process of the pressure-type membrane module according to the related art, a backwash water line 210, a backwash air line 220, and a drain water line 230 are needed. According to the general backwash process of the pressure-type membrane module, the backwash process is performed by combining a backwash process which flows filtered water in the opposite direction of filtration with an air scouring process which scours the membrane surface using air, in which backwash water flows into the pressure-type membrane module through the backwash water line 210 to perform the backwash process to move membrane contaminants adhered to the inside of membrane pores to the membrane surface, the moved contaminants are exfoliated by the air scouring process which scours the membrane surface by air flowing in through the backwash air line 220, and backwash drain water collected through this backwash process is discharged out of the pressure-type membrane through the drain water line 230.

The pressure-type membrane module according to the related art and its backwash process has the following shortcomings.

First, due to its structure, the general pressure-type hollow fiber membrane module has unequal pressure and linear velocity in the module because concentrated water generated after treating inflowing raw water and backwash water and air injected for backwash or air scouring passes along an asymmetrical movement channel between the inlet part at the lower portion of the module and the concentration part on the side at the upper portion, and by this flow of water and air, the hollow fiber membranes move in one direction, as shown in FIG. 6.

Secondly, during the backwash process and the air scouring process performed in the event of membrane module fouling, stresses applied to the hollow fiber membranes around the concentration part increase, and as a result, the membrane may be cut off or stretched and a bottleneck phenomenon (congestion phenomenon) of concentrated water may occur.

Thirdly, contaminants on the membrane surface are not completely removed. Particularly, in the case of the traditional pressure-type hollow fiber membrane module, due to the structural problem with the drain water line located on the side of the module, a dead zone is generated in a flow of backwash water and membrane fouling is not uniformly eliminated.

Fourthly, the air scouring process used for effective cleaning creates a space where air stays in the membrane module, impeding the cleaning.

Fifthly, when a high turbidity material flows in, a serious fouling phenomenon occurs on the membrane surface, resulting in a reduced cleaning effect, and a low cleaning effect requires additional chemical cleaning of the pressure-type membrane module which increases maintenance and operation costs.

FIG. 3 is a diagram illustrating an outer shape of the pressure-type hollow fiber membrane module of the present disclosure, and FIG. 4 is a diagram illustrating an inside of the pressure-type hollow fiber membrane module of the present disclosure, in which the pressure-type hollow fiber membrane module of the present disclosure is provided with an inlet part of raw water at one end of a housing and a cap including a filtration part and a concentration part at the other end, and an O-ring fixing groove (not shown) is installed to prevent concentrated water and drain water from being mixed. Also, the concentration part serving as an outlet part of concentrated water and cleaning air is located at the center of the housing, and a distance from the edge of the housing to a baffle is uniform, contributing to uniform movement of concentrated water and cleaning air.

The pressure-type hollow fiber membrane module of the present disclosure includes a plurality of hollow fiber membranes in the external housing, and a central baffle having a potting material to fix the hollow fiber membranes and a port through which a fluid flows in and out where the hollow fibers are open to at least one adhesive part of the potting material, the central baffle configured to allow a smooth flow of raw water and air within the concentration part. The potting material used to fix the hollow fiber membranes to the housing has hardness in a range of 40 to 70 (Shore D) after curing, and the used potting material has a thickness from 10 mm to 120 mm. A length of the baffle is from 10 mm to 1,000 mm, and an inclination from the top to the bottom of the baffle has an angle from 0° to 10°, and a shape of the baffle has a lattice pattern for a smooth inflow of air and raw water and to prevent a phenomenon in which the flow is obstructed when the membrane is adhered to the baffle by a flow of water or the pressure, and an outer surface of the baffle has embossing in a wavy pattern. The baffle is disposed at the center of the concentration part of the hollow fiber module in a fixable or separable form.

Thus, with the concentration part installed at the center of the pressure-type module, the present disclosure allows concentrated water and cleaning air to uniformly flow in all directions of the housing, which prevents a phenomenon in which the pressure and linear velocity increases or remains stagnant occurring in traditional modules, contributing to effective mechanical cleaning and gaining a membrane fouling reduction advantage, and as the central baffle is provided at the center of the module similar to the concentration part, when air or water goes out of the module, a movement path to the baffle is short and uniform based on a cross sectional area of the module and a density gradient is uniform anywhere, so problems with a difference in concentration gradient and different mechanical stresses for each hollow fiber membrane causing the membranes to get inclined to the concentration part are solved, and the traditional pressure-type hollow fiber membrane module has a limitation on the movement of air and backwash water by a motion or movement of membranes under the high pressure and air injection during backwash, but due to the central baffle installed in the concentration part as shown in FIG. 4, the present disclosure has an advantage of a smooth movement of concentrated water and air, thus enables effective discharge of air during backwash, and is effective in the event of an increased air injection amount.

The air zone for implementing a smooth flow of air is located at the upper portion of the central baffle, and the water zone for implementing a smooth flow of treated water, concentrated water, or backwash water is located at the intermediate portion and the lower portion, wherein a porosity of the air zone is higher than that of the water zone for a quick movement of air flowing up when backwash water and air injection is made simultaneously.

The traditional pressure-type hollow fiber membrane module includes hollow fibers arranged vertically from top to bottom throughout the module and has the same integrity and arrangement of the hollow fibers at top and bottom, but the present disclosure has the hollow fiber membranes arranged with differing integrity and arrangement at top and bottom of the module as shown in FIG. 4, specifically, the same number of hollow fibers are widely distributed at bottom, that is, when air or water flows in through the inlet part of the same cross sectional area, a resistance reduction effect is obtained by increasing dispersion of the hollow fiber membranes or reducing integrity, and the membranes are arranged gradually slantly from bottom to top, leading to a structure susceptible to motion by air injection and an advantage of effective cleaning in the event of inflow of a high turbidity material.

Hereinafter, effects obtained by performing the two-stage backwash process which is divided into two stages, a first stage and a second stage, according to the present disclosure as the backwash process of the pressure-type hollow fiber membrane module are described in detail with reference to FIGS. 2 and 5.

FIG. 2 is a conceptual diagram illustrating the pressure-type membrane module apparatus using the backwash process according to the related art, and FIG. 5 is a conceptual diagram illustrating a backwash method of the pressure-type hollow fiber membrane module apparatus using the two-stage backwash process which is divided into a first stage and a second stage according to the present disclosure.

Describing the backwash process of the pressure-type hollow fiber membrane module apparatus according to the related art and the apparatus using the same with reference to FIG. 2, to perform the backwash process of the pressure-type hollow fiber membrane module according to the related art, the backwash water line 210, the backwash air line 220, and the drain water line 230 are needed. According to the general backwash process of the pressure-type membrane module, the backwash process is generally performed by combining a backwash process which flows filtered water in the opposite direction of filtration with an air scouring process which scours the membrane surface using air, in which backwash water flows into the pressure-type membrane module through the backwash water line 210 to perform the backwash process and moves contaminants adhered to the inside of the membrane pores to the membrane surface, the contaminants moved to the membrane surface is exfoliated by the air scouring process that scours the membrane surface using air flowing in through the backwash air line 220, and backwash drain water collected through this backwash process is discharged out of the pressure-type membrane through the drain water line 230.

FIG. 5 is a conceptual diagram illustrating the pressure-type hollow fiber membrane module apparatus using the two-stage backwash process which is divided into two stages, a first stage and a second stage, according to the present disclosure. The two-stage backwash process according to the present disclosure maximizes a cleaning effect by dividing the traditional backwash process of the pressure-type membrane module into two stages including a first stage and a second stage, and through a long-term experiment, it was found that performing the two-stage backwash process according to the present disclosure was enough effective in the long-term operation of the pressure-type membrane module.

The cleaning method of the pressure-type hollow fiber membrane module with the central baffle is characterized by cleaning the membrane module by a backwash process which flows filtered water into the pressure-type hollow fiber membrane module in the opposite direction of filtration and an air scouring process which scours the membrane surface using air, in which the cleaning method is divided into two stages, a first stage and a second stage, based on a backwash time, with differing backwash water rates and backwash air rates for each stage.

To perform the two-stage backwash process of the pressure-type membrane module according to the present disclosure, a backwash water line 310, a backwash air line 320, and a drain water line 330 are needed similar to the traditional backwash process, and to strengthen the role and effect of the backwash process, the two-stage backwash process may be divided into a first stage and a second stage, in which the amount of backwash water and the amount of backwash air may differ during a period of time of 50:50 divided at an equal ratio based on a total backwash time, to increase a backwash effect.

In the first stage, backwash is performed using the amount of backwash water of 1.5 Q˜2 Q and the amount of backwash air of 100˜200 L/min (LPM), and in the second stage, air scouring is performed with the amount of backwash water reduced to 0.5 Q˜1 Q and the amount of backwash air increased to 200˜400 L/min (LPM).

Seeing the specific embodiment, the two-stage backwash process may use the same amount of backwash water as the traditional backwash process of the pressure-type membrane module, and although the present disclosure uses the same backwash water rate, because the mechanical force is maximized by the two-stage backwash process, the backwash effect would increase.

### Advantageous Effects

With the introduction of the central baffle into the pressure-type hollow fiber membrane module, the present disclosure allows an uniform flow of concentrated water and cleaning air in all directions and prevents a phenomenon in which the pressure and linear velocity increases or remains stagnant occurring in traditional modules, thereby resolving the cut-off or stretching problem of a membrane and a bottleneck phenomenon (congestion phenomenon) of concentrated water, increasing a mechanical cleaning effect, and reducing membrane fouling, as well as providing high pressure and air injection during backwash, and allowing for smooth inflow/discharge of air and backwash water by a motion or movement of membranes.

Also, when compared to a traditional membrane cleaning process involving simultaneous operation of two processes including a backwash process and an air scouring process, the pressure-type membrane module with the central baffle may maximize a cleaning effect of a fouled membrane by performing a backwash process which is divided into two stages, a first stage and a second stage, particularly in which the first stage easily moves contaminants adhered to the inside of the module pores to the membrane surface at a higher amount of water than the traditional backwash process, and the second stage effectively eliminates the contaminants moved to the surface through an air scouring process using an increased amount of air, and this backwash process may effectively slow down a rate of rise of trans-membrane pressure compared to the traditional process, and as a result, may increase an operation time required to reach chemical cleaning and reduce a number of chemical cleaning as well as reduce an amount of air used, gaining an energy saving effect.

Also, as an advantage of a smooth movement of concentrated water and air is obtained by the introduction of the central baffle structure, it is effective in the event of increased amounts of backwash water and air during backwash.

### DESCRIPTION OF DRAWINGS

FIG. 1 is a diagram illustrating a shape of a general pressure-type hollow fiber membrane module.

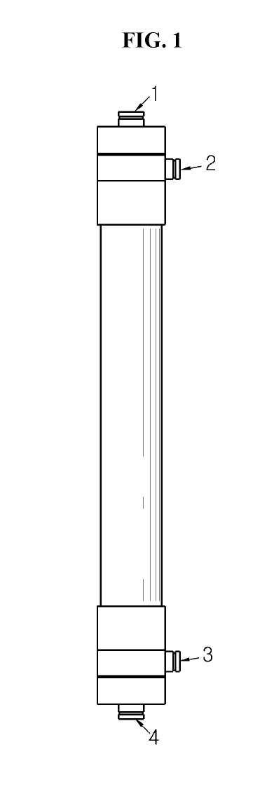

FIG. 2 is a conceptual diagram illustrating a pressure-type membrane module apparatus using a backwash process according to a related art.

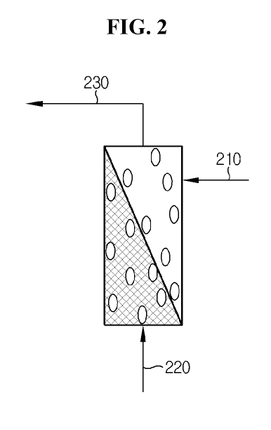

FIG. 3 is a diagram illustrating an outer shape of a pressure-type hollow fiber membrane module of the present disclosure.

FIG. 4 is a diagram illustrating an inside of a pressure-type membrane module with a central baffle of the present disclosure.

FIG. 5 is a conceptual diagram illustrating a backwash method of a pressure-type hollow fiber membrane module using a two-stage backwash process which is divided into two stages, a first stage and a second stage, according to the present disclosure.

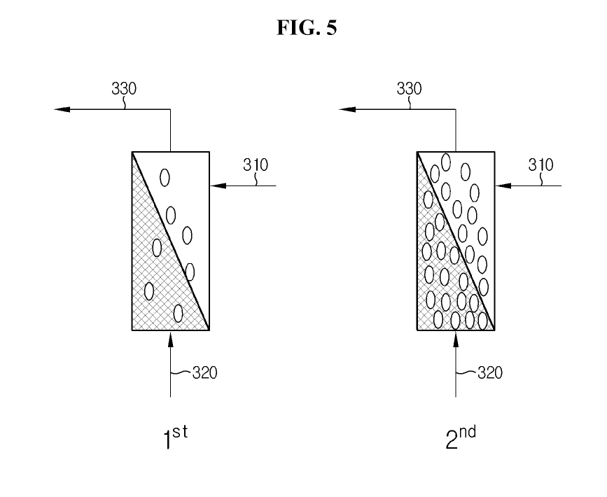

FIG. 6 is a diagram illustrating a pressure distribution in a concentration part of a general pressure-type hollow fiber membrane module.

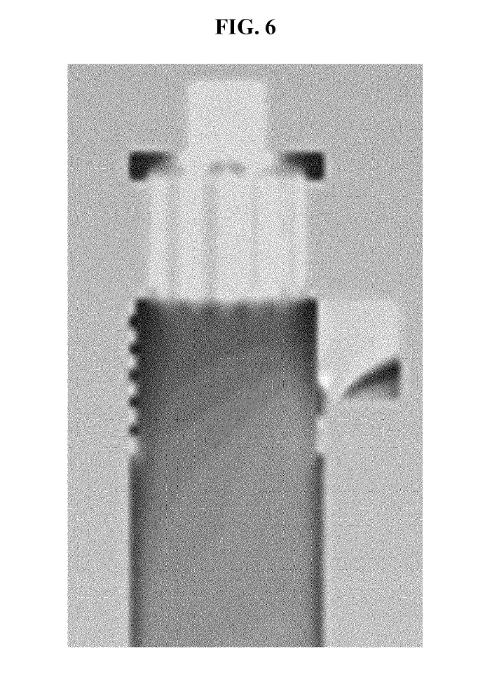

FIG. 7 is a diagram illustrating a shape of a central baffle of the present disclosure.

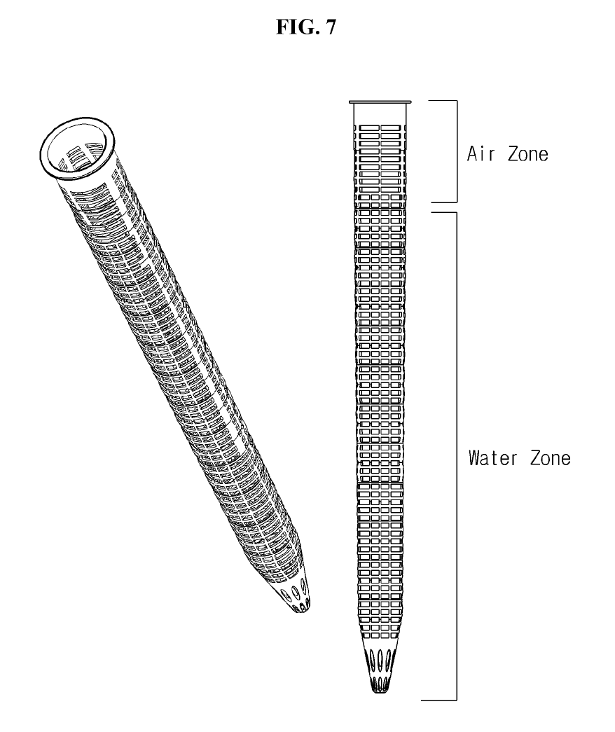

FIG. 8 is a graph illustrating the amount of backwash water and the amount of backwash air vs a backwash time in a backwash method according to a related art.

FIG. 9 is a graph illustrating the amount of backwash water and the amount of backwash vs a backwash time in a backwash method in accordance with a two-stage backwash process according to an exemplary embodiment of the present disclosure.

FIG. 10 is a graph illustrating the amount of backwash water and the amount of backwash air vs a backwash time in a backwash method in accordance with a two-stage backwash process according to an exemplary embodiment of the present disclosure.

FIG. 11 is a graph illustrating a comparison of a trans-membrane pressure according to a related art and a rate of change in trans-membrane pressure in the application of a two-stage backwash process of the present disclosure.

### BEST MODE FOR CARRYING OUT THE INVENTION

Hereinafter, effects of the present disclosure are described in detail through the preferred embodiments of a backwash method of the present disclosure. Rather, the following embodiments are provided to help the understanding of the present disclosure and the scope of the present disclosure is not limited to the following embodiments.

### Embodiment 1

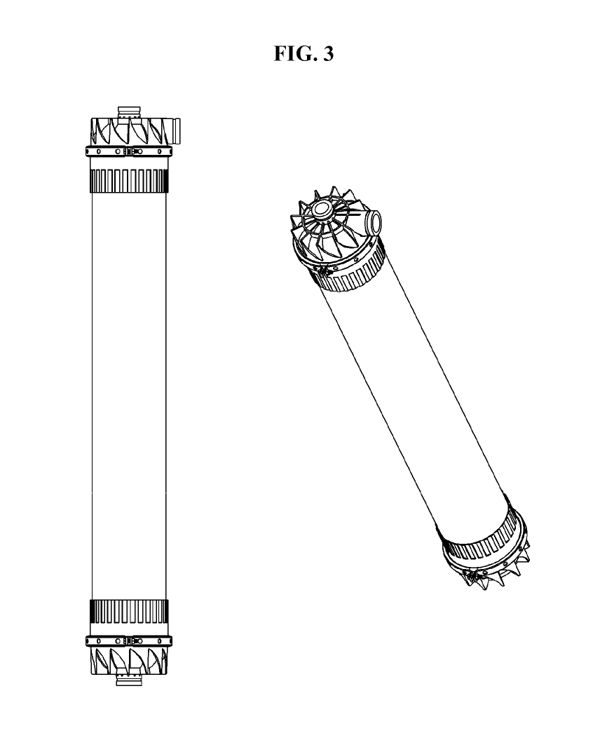

A pressure-type membrane module apparatus was constructed as shown in FIG. 3 by connecting a cylindrical pressure-type module with a central baffle to a backwash water line, a backwash air line, and a drain water line. The amount of backwash water and the amount of backwash air flowing in through the pressure-type membrane module were adjusted through an electric drive valve and a pump.

1. A measuring method based on a backwash time

1) A pressure-type membrane module apparatus is constructed.

2) A total backwash time is determined according to the nature of raw water, and the backwash time is divided at an equal ratio (50:50). The total backwash process time may be determined in consideration of a process recovery ratio within the range of 30˜90 seconds.

3) During a period of time of a first stage in the total backwash time, backwash is performed with the amount of water of 2 Q that is twice higher than the filtration amount of water of the pressure-type membrane module and 200 L/min (LPM) that is as high as 2/3 of a traditional amount of backwash air.

4) During a period of time of a second stage in the total backwash time total backwash time, backwash is performed with the amount of water 1 Q that is equal to the filtration amount of water (Q) of the pressure-type membrane module and 400 LPM that is as high as 4/3 of a traditional amount of backwash air (300 L/min, LPM).

5) Backwash drain water gathered through the backwash process is discharged out of the pressure-type membrane through the drain water line.

The backwash efficiency of the two-stage backwash process was evaluated by the following method, and its result is shown in Table 1.

TABLE 1
The conditions and backwash effects of the two-stage backwash process

| | First backwash stage | | Second backwash stage | | |
|---|---|---|---|---|---|
| | Inflowing water | Inflowing air | Inflowing water | Inflowing air | |
| | (amount of | (amount of | (amount of | (amount of | |
| Backwash mode | backwash water) | backwash air) | backwash water) | backwash air) | Backwash effect |
| Two-stage | 2Q | 200 L/min | 1Q | 400 L/min | After a backwash |
| backwash | | | | | mode is applied, |
| (30/30) sec | | | | | the trans- |
| | | | | | membrane |
| | | | | | pressure of a |
| | | | | | pressure-type |
| | | | | | membrane |
| | | | | | module |
| | | | | | maintains a |
| | | | | | stable state |

2. Backwash method based on turbidity of inflowing raw water
1) The turbidity of inflowing raw water is measured.
2) A two-stage backwash process mode is determined based on the turbidity of inflowing raw water as shown in Table 2.

3) Backwash is performed on the determined two-stage backwash process mode.

4) Backwash drain water gathered through the backwash process is discharged out of the pressure-type membrane through the drain water line.

For the two-stage backwash process based on the turbidity of inflowing raw water, the backwash mode may be designed by the following method, and each backwash process mode and backwash conditions is shown in Table 2.

TABLE 2
Backwash process mode and backwash conditions based on turbidity of inflowing
raw water

| | | First backwash stage | | Second backwash stage | |
|---|---|---|---|---|---|
| | Turbidity of | Inflowing water | Inflowing air | Inflowing water | Inflowing air |
| | inflowing raw | (amount of | (amount of | (amount of | (amount of |
| Backwash mode | water | backwash water) | backwash air) | backwash water) | backwash air) |
| A | 0~2 | 1.5 Q | 100 L/min | 0.5 Q | 300 L/min |
| B | 2~10 | 1.5 Q | 150 L/min | 1 Q | 350 L/min |
| C | 10~100 | 2 Q | 200 L/min | 1 Q | 400 L/min |
| D | 100~300 | 2 Q | 200 L/min | 1 Q | 400 L/min |
| E | 300 or more | 2.5 Q | 250 L/min | 1.5 Q | 450 L/min |

3. Structural feature of a pressure-type hollow fiber membrane module with a central baffle

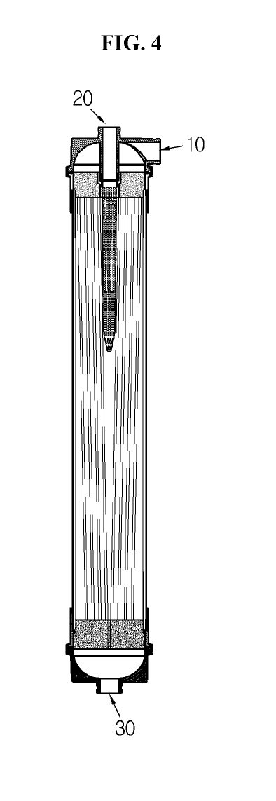

The pressure-type hollow fiber membrane module structure according to the present disclosure includes the central baffle having the same angle as the inclination of the membranes in the concentration part of the module as shown in FIG. 4, and through the central baffle, backwash water and air is effectively discharged. The traditional pressure-type hollow fiber membrane module discharges air only through a concentration pipe, so air is discharged at the same time with backwash water, and its disadvantage is that a discharge area of the traditional module is about 0.0025 m² insufficient for smooth discharge, whereas a discharge area of the pressure-type hollow fiber membrane module with the central baffle of the present disclosure is 0.023 m² that is about 10 times larger than the traditional module, maximizing the backwash effect, and as the drain pipe of concentrated water is installed on the same line as a flow of backwash water, a flow of backwash water concentrates at the center of the module and is discharged therefrom.

4. The effects of the invention in aspect of procedural operation cost

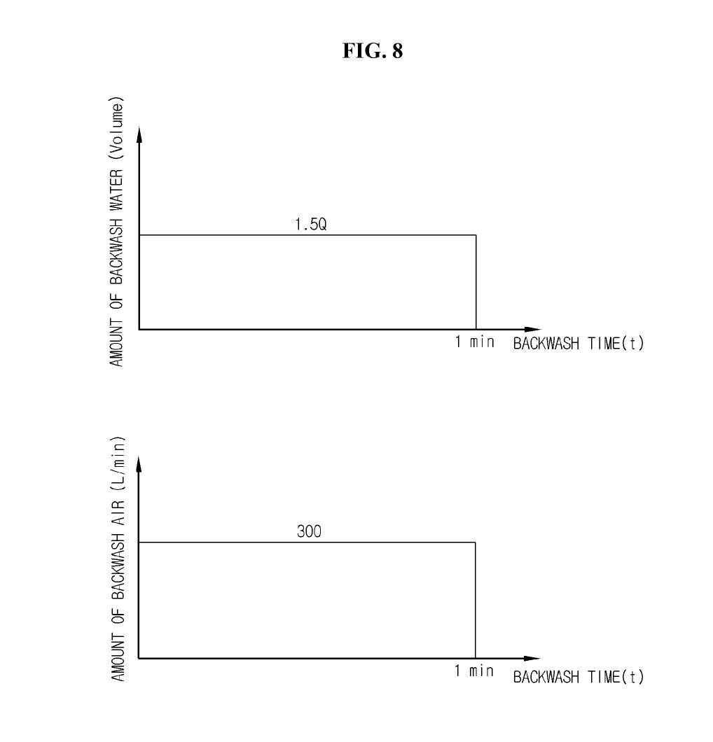

Hereinafter, referring to FIGS. 8 through 10, the effect obtained by performing the two-stage backwash process according to the present disclosure as the pressure-type membrane backwash process is described in detail, together with the traditional backwash process being compared to.

First, FIG. 8 illustrating the result of the related art is described.

FIG. 8 shows the amount of backwash water and the amount of backwash air vs a backwash time in the backwash method according to the related art, in which a horizontal axis represents a backwash time (t) and each vertical axis represents the amount of backwash water (volume) and the amount of backwash air (L/min) permeating the pressure-type membrane module apparatus, and based on the backwash time of 1 minute, the traditional backwash process maintains the amount of backwash water at 1.5 Q that is 1.5 times as high as the filtration amount of water (Q) equally all the time during the backwash time and maintains the amount of backwash air at 300 L/min equally all the time during the backwash time.

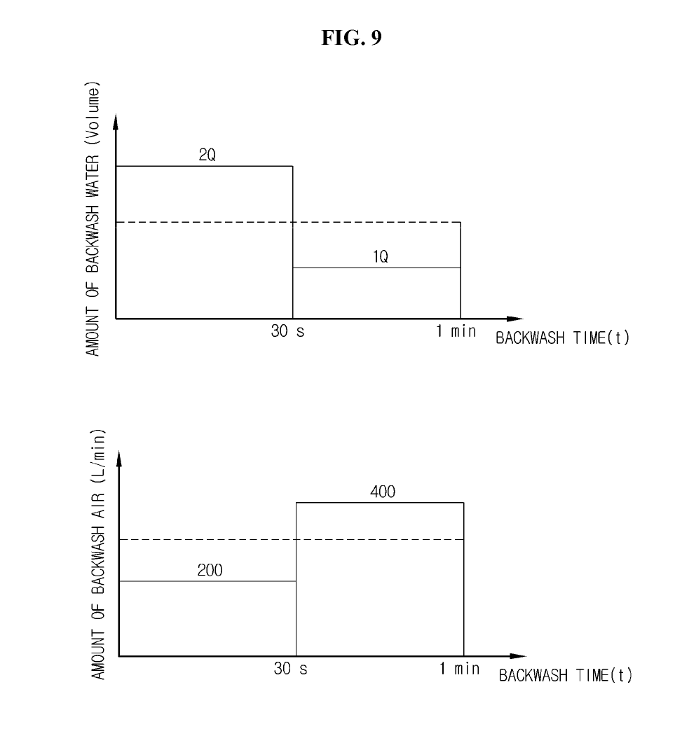

An exemplary embodiment of the present disclosure is described with reference to FIG. 9.

FIG. 9 shows the amount of backwash water and the amount of backwash air vs a backwash time in the backwash method according to an exemplary embodiment of the present disclosure, in which a horizontal axis represents a backwash time (t) and each vertical axis represents the amount of backwash water (volume) and the amount of backwash air (L/min) permeating the pressure-type membrane module apparatus, and based on the backwash time of 1 minute, a first stage and a second stage are each set to 30 seconds, the amount of backwash water (Q) in the first stage is maintained at 2 Q that is twice as high as the filtration amount of water (Q), and the amount of backwash water in the second stage is maintained at 1 Q that is equal to the filtration amount of water (Q), and at the same time, the amount of backwash air in the first stage is maintained at 200 L/min and the amount of backwash air in the second stage is maintained at 400 L/min.

Thus, an average amount of backwash water during the total backwash process time is 1.5 Q and an average amount of backwash air is 300 L/min, and thus, in the first stage, the high amount of backwash water may allow contaminants to be easily moved to the membrane surface using the same energy as the amount of backwash water and the amount of backwash air of the traditional backwash process, and in the second stage, the high amount of backwash air may allow the contaminants to be effectively exfoliated. In the traditional backwash process, to improve the contaminant removal efficiency, increasing the amount of backwash water and the amount of backwash air may be contemplated, but increasing the amount of backwash water and the amount of backwash air results in an increase of the total energy used in the backwash process, leading to an increase in operation/maintenance costs of the entire process, which is not preferred in the aspect of cost efficiency.

Also, merely increasing the amount of backwash water and the amount of backwash air in the traditional backwash process implies, in a pressure-type module of a preset shape, an increase in the amount of backwash water and the amount of backwash air simultaneously supplied into the module, and considering a preset diameter or pipe diameter of the drain water line, it is unfavorable to effective contaminant discharge and brings about a negative result of impeding the effective cleaning by the action of both the increased amount of backwash air and the increased amount of backwash water in the pressure-type module, and thus, aside from a rise of operation/maintenance costs, it is not preferred in terms of cleaning efficiency.

However, the pressure-type hollow fiber membrane module with the central baffle of the present disclosure has an advantage of effective contaminant discharge even though a cleaning method causing an increase in the amount of backwash water and the amount of backwash air is used under the consideration of only cleaning efficiency without taking a rise of operation/maintenance costs into account.

As such, according to the two-stage backwash process of the present disclosure, the first stage easily moves contaminants adhered to the inside of the module pores to the membrane surface at the amount of backwash water of 2 Q that is stronger than that of the traditional water backwash, and the second stage effectively exfoliates the contaminants moved to the surface through the air scouring process using the increased amount of air (400 L/min), and in FIG. 9, each vertical axis represents the amount of backwash water (volume) and the amount of backwash air (L/min; LPM) permeating the pressure-type membrane module apparatus, which is in a proportional relationship to energy inputted in the backwash process, so efficient removal of membrane contaminants by the two-stage backwash process may save the energy and operation cost of the entire process through a reduction in the amount of backwash water and backwash air inputted therein.

### MODE FOR CARRYING OUT THE INVENTION

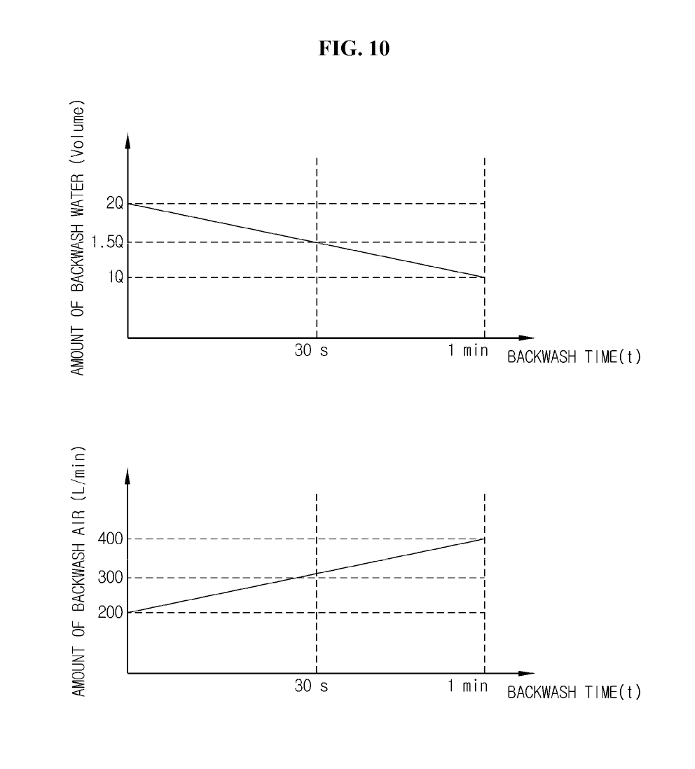

Another exemplary embodiment of the present disclosure is described with reference to FIG. 10.

FIG. 10 shows the amount of backwash water and the amount of backwash air vs a backwash time in a backwash method according to another exemplary embodiment of the present disclosure, in which a horizontal axis represents a backwash time (t) and each vertical axis represents the amount of backwash water (volume) and the amount of backwash air (L/min) permeating the pressure-type membrane module apparatus, and based on the backwash time of 1 minute, the first stage and the second stage are each set to 30 seconds, and the amount of backwash water (Q) linearly decreases from 2 Q that is twice as high as the amount of filtration water (Q) to 1 Q that is equal to the filtration amount of water (Q) from the start of the first stage until the end of the second stage, and at the same time, and the amount of backwash air linearly increases from 200 L/min to 400 L/min to from the start of the first stage to the end of the second stage.

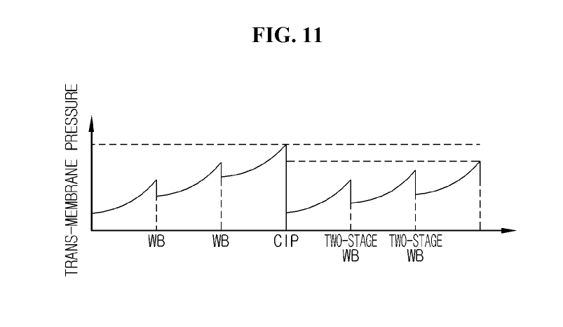

FIG. 11 is a graph illustrating a comparison of a trans-membrane pressure according to the related art and a rate of change in trans-membrane pressure (TMP) in the application of the two-stage backwash process of the present disclosure. In the case of the related art, as a usage time of membranes increase, although a backwash process is performed, remaining contaminants increases, and as time goes, the trans-membrane pressure continuously increases, and at last, it reaches earlier than a time to necessarily perform chemical cleaning (clean in place; CIP) at a preset time point in the process design, however when the two-stage backwash process of the present disclosure is applied, more efficient cleaning of membrane contaminants is enabled, effectively reducing a rate of rise of trans-membrane pressure compared to the traditional process, and when backwash is carried out in the same number of times, the trans-membrane pressure becomes lower than that of the preset time point in the process design, leading to a long-term use of membranes, resulting in an increase in operation time required to reach chemical cleaning and a reduction in number of chemical cleaning as well as a reduction in amount of air used, thereby producing energy saving and operation cost reduction effects.

Table 3 shows a comparison of air usage amount between the traditional general backwash process and the two-stage backwash process of the present disclosure, and when comparing the air usage amount, the two-stage backwash process of the present disclosure has a reduction effect of air usage amount of a maximum of 50% in comparison of the traditional general backwash process, and thus may obtain energy saving and operation cost reduction effects.

TABLE 3
A comparison of air usage amount between the traditional
general backwash process and the two-stage backwash process

| | Traditional general | |
|---|---|---|
| | backwash process | Two-stage backwash process |
| First stage | 300 LPM × 1 | 100~200 LPM × 30 sec = 50~100 L |
| Second stage | min = 300 L | 200~400 LPM × 30 sec = 100~200 L |
| Total | 300 L | 150~300 L |

| | |
|---|---|
| Effect | Air usage amount reduction of a maximum of 50% |

While the preferred embodiments of the present disclosure have been described hereinabove, the present disclosure is not limited to the disclosed specific embodiments. That is, skilled person will appreciate that various changes and modifications may be made to the present disclosure without departing from the spirit and scope of the appended claims, and equivalents to all the proper changes and modifications shall fall within the scope of the present disclosure.

### INDUSTRIAL APPLICABILITY

With the application of a new type of baffle structure that prevents an increase in pressure and linear velocity or a stagnant phenomenon of concentrated water occurring in a pressure-type membrane module and allows for effective mechanical cleaning, thereby reducing membrane fouling and increasing a membrane usage time, and a pressure-type hollow fiber membrane module comprising the same and a new cleaning method which maximizes a cleaning effect of the pressure-type membrane module, maintenance and management of a membrane filtration system is improved, a total energy usage amount reduces and a membrane operation cost reduces, and thus effective application in the water treatment industry is enabled.

1. A central baffle of a cylindrical shape having a hollow inside, the central baffle comprising:
an air zone with at least one backwash hole passing therethrough regularly or irregularly on an outer circumference of the air zone; and
a water zone with at least one backwash hole passing therethrough regularly or irregularly on an outer circumference of the water zone.

2. The central baffle according to claim 1, wherein a size of the backwash hole formed passing therethrough on the outer circumference of the air zone is larger than a size of the backwash hole formed passing therethrough on the water zone.

3. The central baffle according to claim 1, wherein an area of the water zone is larger than an area of the air zone.

4. A pressure-type hollow fiber membrane module comprising an inlet part of raw water, a concentration part of treated water, and a filtration part,
wherein the central baffle defined in claim 1 is located in a module housing on the same axis as the concentration part provided at one end of the pressure-type hollow fiber membrane module, the inlet part of raw water is provided at the other end of the module housing, and the filtration part is provided on a side of the concentration part.

5. The pressure-type hollow fiber membrane module according to claim 4, wherein the central baffle and the concentration part serving as an outlet part of concentrated water and air are located at a center of the housing, and a distance from an edge of the housing to the central baffle is uniform and a movement of concentrated water and air is uniform.

6. A cleaning method of a pressure-type hollow fiber membrane module, wherein the pressure-type hollow fiber membrane module defined in claim 4 is cleaned by a backwash process which flows filtered water into the membrane module in an opposite direction of filtration, and an air scouring process which scours a membrane surface using air, and the cleaning method is divided into two stages including a first stage and a second stage based on a backwash time, and the amount of backwash water and the amount of backwash air differ for each stage.

7. The cleaning method of a pressure-type hollow fiber membrane module according to claim 6, wherein in the first stage, the amount of backwash water is higher than the amount of backwash air, and in the second stage, the amount of backwash air is higher than the amount of backwash water.

8. The cleaning method of a pressure-type hollow fiber membrane module according to claim 6, wherein the amount of backwash water in the first stage is 1.5 Q˜2.5 Q that is 1.5 to 2.5 times higher than the amount of filtration water (Q) of the membrane module, and the amount of backwash water in the second stage is 0.5 Q˜1.5 Q that is 0.5 to 1.5 times higher than the filtration amount of water (Q) of the membrane module.

9. The cleaning method of a pressure-type hollow fiber membrane module according to claim 6, wherein the amount of backwash air in the first stage is 1/3 to 2.5/3 times higher than the traditional amount of backwash air, and the amount of backwash air in the second stage is 1 to 1.5 times higher than the traditional amount of backwash air.

10. The cleaning method of a pressure-type hollow fiber membrane module according to claim 6, wherein a sum of the backwash time of the first stage and the backwash time of the second stage is in a range of 30 to 90 seconds, and the backwash time of the first stage is equal to or different from the backwash time of the second stage.
